(19) United States
(12) Patent Application Publication
(10) Pub. No.: US 2022/0292615 A1
(43) Pub. Date: Sep. 15, 2022

(54) METHOD AND SYSTEM FOR IDENTIFYING NON-USER SOCIAL MEDIA ACCOUNTS

(71) Applicant: Verizon Patent and Licensing Inc., Basking Ridge, NJ (US)

(72) Inventors: Daniel Holliday Hoskins, III, Boulder, CO (US); David Alan Salter, Basking Ridge, NJ (US); Patrick Adam Wagstrom, Coventry, CT (US); Bryce L. Calton, Tulsa, OK (US); Debamalya Choudhury, Bangalore (IN); Sarang Kharpate, Marunji (IN); Vinay Govindan Muralidharan, Bangalore (IN); Romi Malik, Mohali (IN); Kanad Bhowmik, Kolkata (IN)

(21) Appl. No.: 17/695,532

(22) Filed: Mar. 15, 2022

Related U.S. Application Data
(60) Provisional application No. 63/161,234, filed on Mar. 15, 2021.

(51) Int. Cl. G06Q 50/00

(52) U.S. Cl. CPC G06Q 50/01

(57) ABSTRACT

A method, a device, and a non-transitory storage medium are described for identifying non-user social media accounts and that include obtaining a training data set of social media account information; generating additional data elements based on the training data set of social media account information; and generating a predictive model that indicates whether a social media account is a user account or a non-user account based on the obtained training data set and the additional data elements. An unknown social media account is identified for analysis. Social media account information associated with the unknown social media account is retrieved and the additional data elements for the unknown social media account are generated. The predictive model is applied to the social media account information and additional data elements for the unknown social media account to predict whether the unknown social media account is a user account or a non-user account.

### CROSS-REFERENCE TO RELATED APPLICATION

The present application is a non-provisional of and claims priority to U.S. Provisional Patent Application No. 63/161,234, filed on Mar. 15, 2021, the entirety of which is hereby incorporated by reference herein.

### BACKGROUND

Service providers often engage customers via social media platforms to receive product feedback, provide technical or account support, etc. To enhance such interactions, service providers effort to correlate each interaction with a specific customer account. One issue with accomplishing this goal is the presence of non-user social media accounts, which are typically referred to as “bots”. The term “bot” loosely refers to a social media account whose content is not directly generated by a single user, but rather is created by some automated computer algorithm, with or without human intervention. A large number of social media accounts are bot accounts that do not correspond to a particular user. Such bot accounts may emulate human users and may actively attempt to engage service provider social media activities for various purposes, some of which are illicit or nefarious in nature.

### BRIEF DESCRIPTION OF THE DRAWINGS

FIG. 1 is a diagram illustrating an exemplary environment in which an exemplary embodiment of a non-user social media account detection service may be implemented;

FIG. 2 is a diagram illustrating exemplary components of a device that may correspond to one or more of the devices illustrated herein;

FIG. 3 is a block diagram illustrating exemplary components of and information stored in a bot detection engine, consistent with implementations described herein;

FIG. 4 is a diagram illustrating an exemplary process for predicting an account type of a social media account, consistent with implementation described herein.

### DETAILED DESCRIPTION OF EXAMPLE EMBODIMENTS

The following detailed description refers to the accompanying drawings. The same reference numbers in different drawings may identify the same or similar elements. Also, the following detailed description does not limit the invention.

According to exemplary embodiments, a non-user social media account identification system is described. In one implementation, the non-user social media account identification system includes components for retrieving and preparing data sourced from one or more social media platforms relating to a plurality of social media accounts. For example, account profile and metadata information as well as social media activity (i.e., posts, tags, etc.) may be retrieved. As described below, a prediction model may be created based on a corpus of data associated with known user account information (e.g., relating to known user and non-user accounts). Upon model validation, the prediction model may be applied to social media interactions associated with unknown social media accounts. A probabilistic determination regarding whether the unknown social media accounts are user accounts or non-user accounts may be made for subsequent social media interactions. The determination is used to inform future interactions and engagement with the non-known social media accounts via the social media platform.

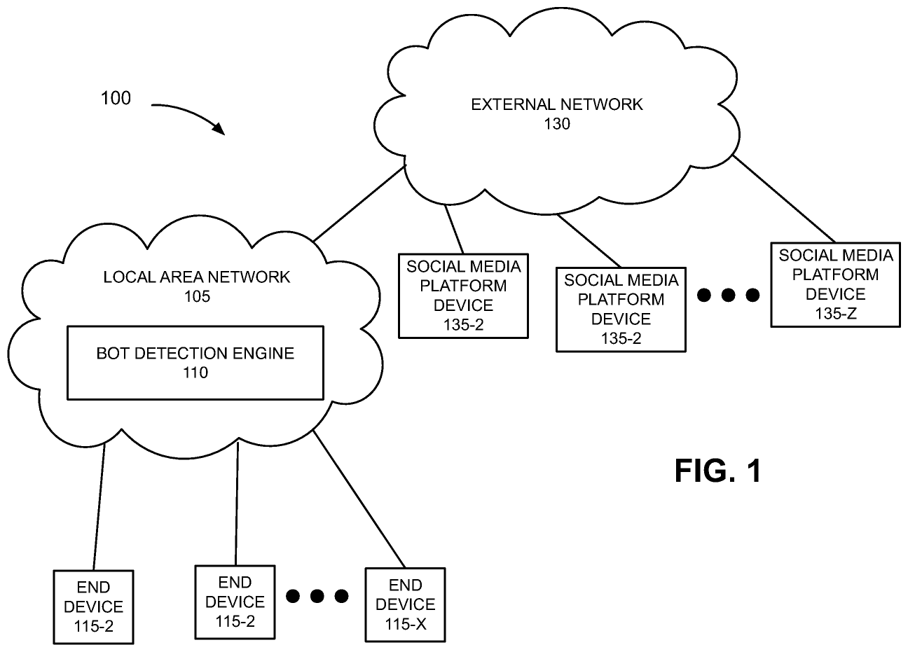

FIG. 1 is a diagram illustrating an exemplary environment 100 in which an exemplary embodiment of the non-user social media account detection service may be implemented. As illustrated, environment 100 includes a local area network 105 and an external network 130. Local area network 105 may include a bot detection engine 110 and end devices 115-1 through 115-X (also referred to as end devices 115 and individually or generally as end device 115). External network 130 may include social media platform devices 135-1 through 135-Z (also referred to as social media platform devices 135 and individually or generally as social media platform device 135).

The number, type, and arrangement of networks illustrated in environment 100 are exemplary. The number, the type, and the arrangement of end devices 115 in local area network 105, as illustrated and described, are exemplary. The number, the type, and the arrangement of social media platform devices 135 in external network 130, as illustrated and described, are exemplary.

A device, such as bot detection engine 110, end device 115, and social media platform device 135 may be implemented according to one or multiple network architectures (e.g., a client device, a server device, a peer device, a proxy device, a cloud device, a virtualized function, and/or another type of network architecture (e.g., Software Defined Networking (SDN), virtual, logical, network slicing, etc.)). Additionally, social media platform device 135 may be implemented according to various computing architectures, such as centralized, distributed, cloud (e.g., elastic, public, private, etc.), edge, fog, and/or another type of computing architecture.

Environment 100 includes communication links between the networks, between bot detection engine 110 and end device 115, and between bot detection engine 110 and social media platform devices 135. Environment 100 may be implemented to include wired, optical, and/or wireless communication links among the devices illustrated. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number and the arrangement of communication links illustrated in environment 100 are exemplary.

Environment 100 may include various planes of communication including, for example, a control plane, a user plane, and a network management plane. Environment 100 may include other types of planes of communication. A message communicated in support of the bot detection engine may use at least one of these planes of communication.

Local area network 105 may include a network that provides the non-user social media account detection service, as described herein. For example, local area network 105 may be implemented as a business network or other geographic-limited locale (e.g., business, etc.).

Bot detection engine 110 may include a device or combination of devices that provides the non-user social media account detection service, as described herein. For example, bot detection engine 110 may be implemented as one or more physical or virtual network devices (e.g., server type devices) or a combination thereof. As described herein, bot detection engine 110 may obtain information from one or more social media platform devices 135, may generate a bot detection model based on the obtained selected elements of the obtained information, and may apply the generated model to social media interactions to determine whether user accounts associated with the social media interactions are non-user accounts (e.g., bot accounts). Although bot detection engine 110 is illustrated as residing on local area network 105, in other implementations, bot detection engine 110 may reside on external network 130, or may be configured as a network service having functionality distributed across one or more networks.

End device 115 may include a device that obtains information and has communication capabilities to at least transmit the information to local area network and/or external network 130. For example, end device 115 may be implemented as a computer (e.g., desktop, laptop, etc.), a mobile device (e.g., a smartphone, a tablet, etc.), etc., that may receive information from and/or transmit information to social media platform devices 135 and bot detection engine 110 as described herein.

External network 130 may include various types of networks external from local area network 105. For example, external network 130 may include a wired network, a wireless network, an optical network, a private network, a public network, a terrestrial network, and/or a satellite network. By way of further example, external network 130 may include the Internet, a service provider network, a transport network, a data network, an application layer network (e.g., a cloud network, etc.), the World Wide Web, a radio access network (RAN), a core network, a packet-switched network, and/or other types of networks not specifically described herein.

Depending on the implementation, external network 130 may include various network devices, such as social media platform devices 135. For example, social media platform devices 135 may provide various applications, services, or other type of end device assets, such as servers (e.g., web, application, cloud, etc.), mass storage devices, and/or data center devices. As described herein, social media platform devices 135 may provide information elements relating to users and accounts on the social media platform via one or more application programming interfaces (APIs). For example, social media platform devices 135 may provide or support an API for developers that provides access to user account information and social media activity information.

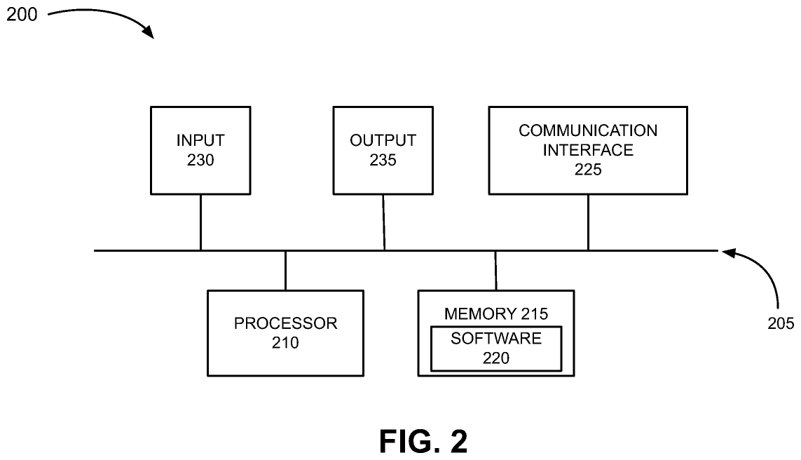

FIG. 2 is a diagram illustrating exemplary components of a device 200 that may be included in one or more of the devices described herein. For example, device 200 may correspond to bot detection engine 110, end device 115, and social media platform device 135, and other types of network devices or logic, as described herein. As illustrated in FIG. 2, device 200 includes a bus 205, a processor 210, a memory/storage 215 that stores software 220, a communication interface 225, an input 230, and an output 235. According to other embodiments, device 200 may include fewer components, additional components, different components, and/or a different arrangement of components than those illustrated in FIG. 2 and described herein.

Bus 205 includes a path that permits communication among one or multiple components of device 200. For example, bus 205 may include a system bus, an address bus, a data bus, and/or a control bus. Bus 205 may also include bus drivers, bus arbiters, bus interfaces, clocks, and so forth.

Processor 210 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 210 may be implemented as hardware (e.g., a microprocessor, etc.), a combination of hardware and software (e.g., a SoC, an ASIC, etc.), may include one or multiple memories (e.g., cache, etc.), etc.

Processor 210 may control the overall operation, or a portion of operation(s) performed by device 200. Processor 210 may perform one or multiple operations based on an operating system and/or various applications or computer programs (e.g., software 220). Processor 210 may access instructions from memory/storage 215, from other components of device 200, and/or from a source external to device 200 (e.g., a network, another device, etc.). Processor 210 may perform an operation and/or a process based on various techniques including, for example, multithreading, parallel processing, pipelining, interleaving, etc.

Memory/storage 215 includes one or multiple memories and/or one or multiple other types of storage mediums. For example, memory/storage 215 may include one or multiple types of memories, such as, a random access memory (RAM), a dynamic random access memory (DRAM), a static random access memory (SRAM), a cache, a read only memory (ROM), a programmable read only memory (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 215 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 215 may include drives for reading from and writing to the storage medium.

Memory/storage 215 may be external to and/or removable from device 200, such as, for example, a Universal Serial Bus (USB) memory stick, a dongle, a hard disk, mass storage, off-line storage, or some other type of storing medium (e.g., a compact disc (CD), a digital versatile disc (DVD), a Blu-Ray disk (BD), etc.). Memory/storage 215 may store data, software, and/or instructions related to the operation of device 200.

Software 220 includes an application or a program that provides a function and/or a process. As an example, with reference to bot detection engine 110, software 220 may include an application that, when executed by processor 210, provides a function of the non-user social media account detection service, as described herein. Additionally, for example, with reference to end device 115, software 220 may include an application that, when executed by processor 210, provides an interface for interacting with the non-user social media account detection service. Software 220 may also include firmware, middleware, microcode, hardware description language (HDL), and/or other form of instruction. Software 220 may also be virtualized. Software 220 may further include an operating system (OS) (e.g., Windows, Linux, Android, proprietary, etc.).

Communication interface 225 permits device 200 to communicate with other devices, networks, systems, and/or the like. Communication interface 225 includes one or multiple wireless interfaces, wired interfaces, and/or optical interfaces. For example, communication interface 225 may include one or multiple transmitters and receivers, or transceivers. Communication interface 225 may operate according to a protocol stack and a communication standard. Communication interface 225 may include an antenna.

Communication interface 225 may include various processing logic or circuitry (e.g., multiplexing/de-multiplexing, filtering, amplifying, converting, error correction, application programming interface (API), etc.). Communication interface 225 may be implemented as a point-to-point interface, a service based interface, etc. Communication interface 225 may be implemented to include logic that supports the non-user social media account detection service, such as the transmission and reception of messages (e.g., commands, etc.), packet filtering, establishment and tear down of a connection, and so forth, as described herein.

Input 230 permits an input into device 200. For example, input 230 may include a keyboard, a mouse, a display, a touchscreen, a touchless screen, a button, a switch, an input port, speech recognition logic, and/or some other type of visual, auditory, tactile, etc., input component. Output 235 permits an output from device 200. For example, output 235 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, etc.). Device 200 may be implemented in the same manner. For example, device 200 may be instantiated, created, deleted, or some other operational state during its life-cycle (e.g., refreshed, paused, suspended, rebooting, or another type of state or status), using well-known virtualization technologies (e.g., hypervisor, container engine, virtual container, virtual machine, etc.) in a network.

Device 200 may perform a process and/or a function, as described herein, in response to processor 210 executing software 220 stored by memory/storage 215. By way of example, instructions may be read into memory/storage 215 from another memory/storage 215 (not shown) or read from another device (not shown) via communication interface 225. The instructions stored by memory/storage 215 cause processor 210 to perform a process and/or a function, as described herein. Alternatively, for example, according to other implementations, device 200 performs a process and/or a function as described herein based on the execution of hardware (processor 210, etc.).

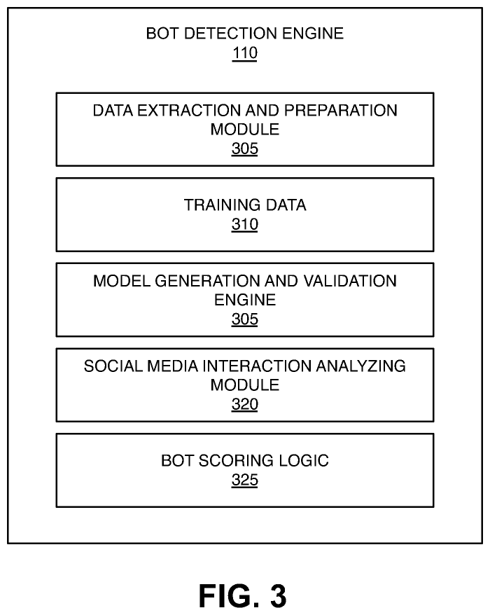

FIG. 3 is a block diagram illustrating exemplary components of and information stored in bot detection engine 110 consistent with implementations described herein. The components of bot detection engine function 110 may be implemented, for example, via processor 210 executing instructions from memory/storage 215. Alternatively, some or all of the functional components of bot detection engine 110 may be implemented via hard-wired circuitry. The information stored in bot detection engine 110 may be stored as a database in memory/storage 215, for example. As shown, bot detecting engine 110 may include data extraction and preparation module 305, training data 310, model generation and validation engine 315, social media interaction analyzing module 320, and bot scoring logic 325. Although components 305-325 are shown to be separate elements in FIG. 3, any of these components may be combined into fewer elements, such as into a single component, or divided into more components as may serve a particular implementation.

Data extraction and preparation module 305 includes logic configured to retrieve or otherwise capture information associated with a plurality of social media accounts. In some implementations, such information may be retrieved via a developer API provided by a social media platform. In other implementations, the information may be capture or “scraped” from information that has been made publicly available by the social media platforms. Consistent with implementations described herein, information retrieved from social media platform devices 135 may include account level information and post level information. Account level information includes information and metrics relating to the social media user account, such as user name (i.e., handle), profile content, geographic location, follower/following counts, repost/reply counts, etc. Post level information comprises the content and associated metadata (e.g., time, date, posting software, etc.) associated with individual social media posts associated the with particular user accounts.

In some implementations, the account level information contains both data that account creators are required to provide during account creation as well as optional data that an account creator may submit during or subsequent to account creation. Exemplary account level information may include direct level account information or information derived from the other available fields from the social media platform, such as: post count, follower count, following count, following-follower ratio, whether the account is “verified,” a total number of “likes”, a number of days since account creation, engagement count, number of tweets per day, account name match, author name (self-declaration), screen name (self-declaration), user description (e.g., bio) (self-declaration), account creator (self-declaration), and source name based (self-declaration).

Consistent with implementations described herein, post level information may include information regarding a predetermined recent number social media posts associated with a particular account. For example, information regarding a most recent 200 posts for each social media account may be retrieved. Although a most recent 200 posts is reference herein, it should be understood that any suitable number of posts may be used, to balance efficiency, temporal relevancy, and thoroughness. Exemplary post level information may include, total latest record, the number of non-repost posts, the number of replies, the number of repost posts, the percentage of repost posts, the percentage of posts that include “@”, the percentage of posts that include “#”, the percentage of posts that include HTTPS, the percentage of posts that include “|”, the percentage of posts that include “vote”, the percentage of posts that include “via@”, the percentage of posts that include “viaHTTPS”, the percentage of posts that include “/”, the percentage of posts that include “Register”, the percentage of posts that include “signup”, the percentage of posts that include “//”, the percentage of posts that include “Moreinfo”, the percentage of posts that include “:”, the percentage of posts that include “!”, the percentage of posts that include “Many Symbol”, and the percentage of posts that include particular keywords relating to a particular service provider, retailer, etc.

Consistent with implementations described herein, in addition to the retrieved or captured social media account information, data extraction and preparation module 305 may also generate additional data elements for each social media account by combining one or more elements of retrieved data as Boolean or true/false values. In particular, the additional data elements may include indications of whether particular elements of social media account information have certain defined characteristics or meet particular, identified criteria relevant to a non-user account determination.

For example, data elements may be generated indicating: whether, if 100% of an account's posts are reposts, any of the posts were replies; whether, if 100% of an account's posts are reposts, none of the posts were replies; whether, if 100% of the posts contain the “|” character, none of the posts are replies; whether, if at least 80% of the posts contain the “via@” string, none of the posts are replies; and whether either the self-declaration description or the self-declaration screen name of the account includes any of a predetermined number of character strings indicating that the account is associated with a news outlet is some manner. Such news-related character strings may include the following character strings: “news,” “magazine,” “publication,” “production services,” “creative,” “newswire,” “report,” “author,” “article writing,” “newzz,” “maintenance services,” “founder,” “CEO,” “leader,” “helping organizations,” “management,” “freelance,” “writer/analyst,” “fiber networks,” “communications,” “analyst,” “photography,” “media,” “#media,” “#science,” “#technology,” “freelancer,” “blogger,” “SEO,” “artist,” “information and technology,” “interviews,” “executive,” “marketer,” “consultant,” “investors,” and “investor.” It should be understood that this listing of possible character strings is exemplary only and that any suitable and relevant character string may be used.

As described herein, training data 310 may store a data set of social media account information for a plurality of social media accounts retrieved by data extraction and preparation module 305 from social media platform devices 135. As described above, for account information stored in training data 310, identification of whether the particular accounts are user or non-user (bot) accounts is independently known.

Model generation and validation engine 315 may include logic to generate a model for accurately predicting whether an account is a user account or a non-user (bot) account based on a combination of features regarding the social media account based on the above-identified features, or combinations thereof. Consistent with implementations described herein, model generation and validation engine 315 may include one or more machine learning algorithms to generate a score indicative of the likelihood that a particular social media account is a user account or a non-user account. For example, training data 310 may be input into a gradient boosting classification algorithm to generate a model that accurately predicts whether a particular social media account is a user account or a non-user account based on a collection of social media account feature data. Gradient boosting is a type of supervised machine learning that relies on an iterative combination of relatively weak prediction models or decision trees to minimize overall prediction error. Additional machine learning algorithms that may be used include, for example, a neural network, a regression analysis, a random forest analysis, etc. Model generation and validation engine 315 may validate the resulting model based on the known social media account types (e.g., user or non-user) for each record in training data 310.

In an exemplary implementation, model generation and validation engine 315 may identify a collection of dominant features which form the primary basis of predicting social media account type. In particular, such dominant features may include:

1) a total number of reply posts (e.g., in the social media account's most recent 200 posts),

2) the Boolean value indicating whether either the self declaration description or the self-declaration screen name of the account includes any of a predetermined number of character strings indicating that the account is associated with a news outlet,

3) a Boolean value indicating whether the source of the post intersects with a set of “renowned” social media platforms. As used herein, “renowned” social media platforms refer to sources that typically charge a fee to access. Examples include Microsoft® Power Platform®, TweetDeck®, Mailchimp®, etc.,

4) a Boolean value indicating whether the source for any of the account's 200 most recent posts contains a case-insensitive match with any of the following patterns related to bots: [‘bot’, ‘robot’, ‘b0t’, ‘bots’, ‘robots’], though other patterns are also contemplated,

5) a Boolean value indicating whether any text string in account self-declaration description contains a case-insensitive match with a pattern in the list [‘bot’, ‘robot’, ‘b0t’, ‘bots’, ‘robots’] AND is NOT an exact match for an unambiguous non-bot term, such as “both,” “botany,” “bottle,” etc.,

In addition to the above dominant features, the additional captured features or additional data elements described above may also be impactful to the accuracy of the model.

Social media interaction analyzing module 320 may include logic configured to receive requests for social media account type determination. For example, social media interaction analyzing module 320 may receive a request from an end device 115 associated with a social media engagement representative requesting a prediction regarding a particular social media account. In other implementations, social media interaction analyzing module 320 may monitor all social media posts that tag the service provider or meet other predefined criteria to proactively determine a likely social media account type, and to further inform future engagement activities. Examples of tagging may include “mentions,” “@” hash tagging (#), etc.

In response to either a request or a periodic or on-demand review, social media interaction analyzing module 320 may be configured to request that data extraction and preparation module 305 retrieve the above-identified social media account and post information for the identified social media account(s). For example, data extraction and preparation module 305 may retrieve the account level and post level data associated with the social media account(s) in question.

Bot scoring logic 325 may include logic configured to score the social media account(s) based on the model determined by model generation and validation engine 315. For example, bot scoring logic 325 may be configured to apply the validated model to the data retrieved by data extraction and preparation module 305 and generate a bot or non-bot score based thereon. In some implementations, a numerical score indicative of a confidence of the model may be generated, while in other implementations, a binary yes/no indication (score) may be provided.

In implementations in which the request for account type prediction was received from an end device 115, the resulting score generated by bot scoring logic 325 may be transmitted or delivered to the requesting end device 115 (or a user of end device 115). In implementations in which account type predictions are made automatically or autonomously based on the content of social media posts, bot scoring logic 325 may maintain a database of social media accounts that includes information identifying the social media accounts and an indication of the account type prediction. In such an implementation, the database may be queried in determining subsequent social media engagement activities.

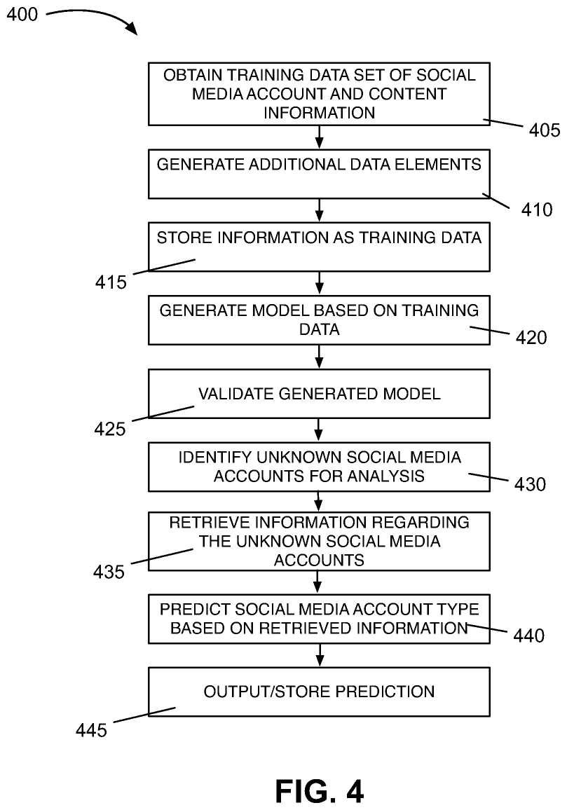

FIG. 4 is a flow diagram that conceptually illustrates an exemplary process 400 for predicting whether a social media account is a user account or a non-user account consistent with implementations described herein. In one implementation, process 400 may be implemented by bot detection engine 110. In other implementations, process 400 may be implemented by other component(s) in local area network 105 or external network 130, such as via a network supported service.

As shown in FIG. 4, process 400 may include obtaining a training data set of social media account and content information (block 405). For example, as described above, data extraction and preparation module 305 may retrieve social media content for a plurality of social media accounts having a known account type from one or more social media platform devices 135. The retrieved data may include both account level and post-level data. Additional data elements may be generated based on the retrieved social media account data (block 410). For example, various data elements relating to text or character strings appearing in social media posts, alone, or in combination with other data elements may be generated. The retrieved social media account data and additional data elements may be stored as training data (block 415). For example, the social media account information and additional data may be stored in training data 310.

A model for predicting a social media account type may be generated based on the training data 310 (block 420). For example, model generation and validation engine 315 may perform a machine learning regression, such as a gradient boosted regression, to determine a collection of variables and relative impact that most strongly predicts the account type for the data in training data 310. The model may be validated using the known social media account types (block 425).

One or more unknown social media accounts may be identified for analysis (block 430). For example, social media interaction analyzing module 320 may receive a request to predict an account type for a particular social media account. Alternatively, social media interaction analyzing module 320 may autonomously predict social media account types for social media accounts meeting certain criteria, such as those that mention or attempt to directly communicate with a particular entity associated with bot detecting engine 100, such as a service provider, a vendor, a manufacturer, a retailer, etc.

Information regarding the identified social media account(s) may be retrieved for analysis (block 435). For example, social media interaction analyzing module 320 may direct data extraction and preparation module 305 to retrieve account level and post level data for the identified social media account. Similar to the processing performed during model generation, data extraction and preparation module 305 may further generate the additional account type determination related data elements based on the retrieved social media account data.

An account type for each of the identified social media accounts may be predicted based on the generated model (block 440). For example, bot scoring logic 325 may apply the model developed by model generation and validation engine 315 to the retrieved/generated social media account data. The prediction may be output to a requesting entity or database for use in determining subsequent social media engagement activities (block 445).

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described with regard to the processes illustrated in FIG. 4, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 510, etc.), or a combination of hardware and software (e.g., software 520).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 510) of a device. A non-transitory storage medium includes one or more of the storage mediums described in relation to memory/storage 515. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method for identifying non-user social media account, comprising:
obtaining a training data set of social media account information;
generating additional data elements based on the training data set of social media account information;
generating a predictive model that indicates whether a social media account is a user account or a non-user account based on the obtained training data set and the additional data elements;
identifying an unknown social media account for analysis;
retrieving social media account information associated with the unknown social media account;
generating the additional data elements for the unknown social media account;
applying the predictive model to the social media account information and additional data elements for the unknown social media account to predict whether the unknown social media account is a user account or a non-user account.

2. The method of claim 1, wherein the social media account information comprises account level information and post level information.

3. The method of claim 1, wherein the account level information includes account metric information and self-declaration information.

4. The method of claim 3, wherein the additional data elements comprise indications of whether one or more elements of the social media account information have certain defined characteristics.

5. The method of claim 3, wherein the additional data elements include indications of whether an item of self-declaration information matches any of a plurality of particular character strings.

6. The method of claim 1, further comprising applying one or more machine learning algorithms to the social media account information and additional data elements to generate the predictive model.

7. The method of claim 6, wherein the one or more machine learning algorithms comprises at least a gradient boosting regression algorithm.

8. The method of claim 1, wherein identifying an unknown social media account for analysis comprises receiving a request that specifies the unknown social media account.

9. The method of claim 1, wherein identifying an unknown social media account for analysis comprises monitoring one or more social media platforms for one or more unknown social media accounts that meet predefined criteria.

10. The method of claim 1, further comprising performing at least one of:
outputting or storing the prediction regarding whether the unknown social media account is a user account or a non-user account.

11. A device comprising:
a communication interface;
a memory, wherein the memory stores instructions; and
a processor, configured to:
obtain a training data set of social media account information;
generate additional data elements based on the training data set of social media account information;
generate a predictive model that indicates whether a social media account is a user account or a non-user account based on the obtained training data set and the additional data elements;
identify an unknown social media account for analysis;
retrieve social media account information associated with the unknown social media account;
generate the additional data elements for the unknown social media account; and
apply the predictive model to the social media account information and additional data elements for the unknown social media account to predict whether the unknown social media account is a user account or a non-user account.

12. The device of claim 11, wherein the social media account information comprises account level information and post level information.

13. The device of claim 11, wherein the account level information includes account metric information and self-declaration information.

14. The device of claim 13, wherein the additional data elements comprise indications of whether one or more elements of the social media account information have certain defined characteristics.

15. The device of claim 13, wherein the additional data elements include indications of whether an item of self-declaration information matches any of a plurality of particular character strings.

16. The device of claim 11, wherein the processor is further configured to apply one or more machine learning algorithms to the social media account information and additional data elements to generate the predictive model.

17. The device of claim 16, wherein the one or more machine learning algorithms comprises at least a gradient boosting regression algorithm.

18. The device of claim 11, wherein the processor configured to identify an unknown social media account for analysis is further configured to:
receive a request that specifies the unknown social media account; or
monitor one or more social media platforms for one or more unknown social media accounts that meet predefined criteria.

19. A non-transitory, computer-readable storage medium storing instructions executable by a processor of a computational device, which when executed cause the computational device to:
obtain a training data set of social media account information;
generate additional data elements based on the training data set of social media account information;
generate a predictive model that indicates whether a social media account is a user account or a non-user account based on the obtained training data set and the additional data elements;
identify an unknown social media account for analysis;
retrieve social media account information associated with the unknown social media account;
generate the additional data elements for the unknown social media account; and
apply the predictive model to the social media account information and additional data elements for the unknown social media account to predict whether the unknown social media account is a user account or a non-user account.

20. The non-transitory, computer-readable storage medium of claim 19,
wherein the social media account information comprises account level information and post level information,
wherein the account level information includes account metric information and self-declaration information, and
wherein the additional data elements comprise indications of whether one or more elements of the social media account information have certain defined characteristics.
